(19) United States
(12) Patent Application Publication
(10) Pub. No.: US 2016/0381085 A1
(43) Pub. Date: Dec. 29, 2016

(54) TAMPER-PROOF COMMUNICATION CHANNEL

(71) Applicant: Pagefair IIMITED, Dublin (IE)

(72) Inventors: Sean Blanchfield, Dublin (IE); Brian McDonnell, Dublin (IE); Neil O'Connor, Dublin (IE); Miles McGuire, Dublin (IE); Jonathan Frawley, Dublin (IE)

(73) Assignee: Pagefair Limited, Dublin (IE)

(21) Appl. No.: 15/193,198

(22) Filed: Jun. 27, 2016

Related U.S. Application Data
(60) Provisional application No. 62/185,068, filed on Jun. 26, 2015.

(51) Int. Cl. H04L 29/06; H04L 29/12; H04L 29/08

(52) U.S. Cl. CPC H04L 65/105; H04L 67/1085; H04L 67/06; H04L 67/2804; H04L 61/1535; H04L 61/1582

(57) ABSTRACT

A method for preventing tampering with the accessibility of resources specified by Universal Resource Locators (URLs) comprising establishing a tamper-proof channel between a client and a proxy; requesting URL content via the tamper-proof channel; forwarding URL requests from the proxy; and returning responses to the client via the tamper-proof channel.

### FIELD OF THE INVENTION

The present application relates in general to the addressing scheme by which resources on the internet are accessed, namely Uniform Resource Locators (URLs), and more particularly to methods to ensure the reliable delivery of internet content to client/users by preventing intermediaries from selectively tampering with the accessibility of content by filtering URLs.

### BACKGROUND

The most highly-visited websites in the world make money through the display of advertising on behalf of other businesses. The global online advertising market is expected to grow by 16% to over $170 billion US dollars in 2015. This advertising expenditure permits websites to provide their content free of charge to consumers.

In the early years of the World Wide Web it was common for computing experts to modify their computer settings to prevent them from communicating with internet servers that were known to host display advertising, thereby marginally decreasing the time it would take to download web pages. In recent years, a number of mainstream software tools have emerged that use similar techniques to prevent the display of advertising on all web pages.

Many of these tools are downloadable extensions for popular web browsers, which automatically block communication with thousands of internet servers. An exemplar is the “AdBlockPlus” extension, which is used by hundreds of millions of web users, and prevents the display of advertising on all websites they visit.

Other tools can be installed and configured at a network level to achieve the same effect. An exemplar is the “Privoxy” tool, which runs on a computer network and modifies any web traffic that is configured to pass through it.

Due to these blocking tools, many advertising-supported businesses are closing down due to declining revenues.

These tools, and others that employ similar techniques, inflict secondary damage on web businesses. Much functionality of modern websites depends on the web browser's ability to execute javascript source code. The blocking tools discussed above frequently attack javascript execution by preventing source code files from being downloaded. They can also prevent javascript code from communicating with specified internet servers. This is typically used to stop websites collecting web-analytics data about their visitors, upon which they depend in day-to-day decision making. This form of attack also damages the businesses that provide these web-analytics services, and can be arbitrary directed at any of the growing number of other businesses that utilize similar software architectures.

By selectively blocking parts of web pages, these tools act to tamper with the intended user experience. This is detrimental to the businesses that publish this content, who wish to maintain the integrity of the functionality, presentation and branding of their website, as well as ensuring that any advertising is correctly displayed.

It would therefore be advantageous to have a system whereby publishers of websites could protect their websites from such tampering. Additional advantages and novel features of this invention shall be set forth in part in the description that follows, and in part will become apparent to those skilled in the art upon examination of the following specification or may be learned by practice of the invention. The advantages of the invention may be realized and attained by means of the instrumentalities, combinations, compositions, and methods particularly pointed out in the appended claims.

### SUMMARY

The present teachings disclose a system and method to prevent hackers or automated systems tampering with online documents, applications or appliances by selectively filtering access to online resource by inspecting their URLs.

### BRIEF DESCRIPTION OF DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a diagram depicting the interaction between components of the conventional system by which content is delivered to clients;

FIG. 2 is a flow chart depicting the steps performed in the conventional system by which content is delivered to clients;

FIG. 3 is a diagram depicting the detailed interaction between components of the conventional system by which peer-to-peer (P2P) connections are established;

FIG. 4 is a flow chart depicting the steps performed in the conventional system by which P2P connections are established;

FIG. 5 is a diagram depicting the detailed interaction of the components in the present system and method set out in this application;

FIG. 6 is a flow chart depicting the augmented system and method by which a P2P connection is established; and

FIG. 7 is a flow chart depicting the augmented system and method by which resources are loaded through a tamper-proof channel.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. In order to fully appreciate the present teachings, it is necessary to first outline the conventional system and method by which content is delivered to clients.

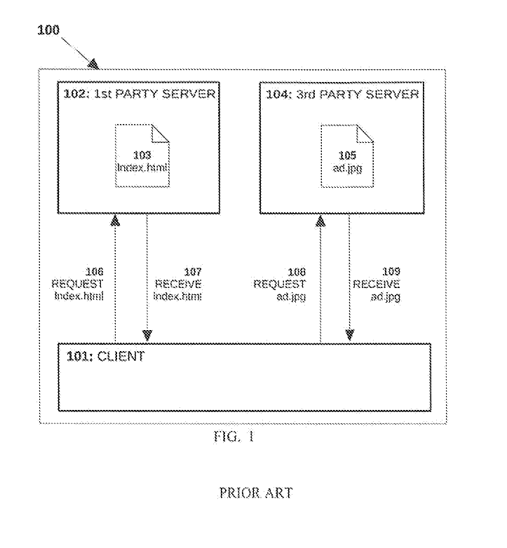

The conventional system and method is best defined with reference to FIG. 1. This system 100 comprises of three components: a client 101, a 1^{st}-party server 102, and a 3^{rd}-party server 104. It should be understood that “client” refers to any software or hardware that downloads data from the internet using URLs. Examples include but are not limited to: a web browser, a plugin running in a web browser, a video game, an application running on a mobile device, software running on a set-top TV box, or any other internet-enabled appliance. It should also be understood that although only a single 3^{rd}-party server 104 is shown in FIG. 1 for ease of understanding, in practice the system 100 may contain a plurality of 3^{rd}-party servers 104 that the client 101 is capable of communicating with to obtain additional resources necessary for the correct functioning of the system. It should also be understood that in the some embodiments, the 1^{st}-party server 102 may also share the same role as the 3^{rd}-party server 104.

The 1^{st}-party server 102 hosts a document 103 (called “index.html” in this example). It should be understood that the term “document” may refer to a HTML document, but may equivalently refer to any other kind of document containing a manifest of additional online resources. In some embodiments clients may download pre-configured resources without first downloading a document. For example a client may automatically download configuration files, databases, and updates. These clients may be considered to have been preloaded with a document.

A separate 3^{rd}-party server 104 hosts a resource 105 (called “ad.jpg” in this example). As would be evident to a skilled person in the art, the term “resource” refers to an online resource that is available via a URL. Documents normally refer to a plurality of additional resources that clients should download. For example, HTML documents may included references to elements including CSS files, image files, video files, applets or javascript files. Resources directly referred to by the document may in turn refer to other resources. For example, a javascript file referred to by the document can in turn refer to an image file located at a URL.

In the conventional system, the client 102 first downloads the document 103 from the 1^{st}-party server 102 as shown by messaging 106 and 107 of FIG. 1. When this download is complete, it downloads any additional resources specified by the document, such as the resource 105, which is hosted on a 3^{rd} party server 104. Messaging 108 and 109 of FIG. 1 shows this downloading of additional resources.

The terms and words used in the following description and claims are not is limited to the bibliographical meanings, but are merely used by the inventor to enable a clear and consistent understanding of the invention. Accordingly, it should be be apparent of those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on”, “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Included in the description are flowcharts depicting examples of the methodology which may be used to ensure the reliable delivery of Internet content using the tamper-proof system of the present invention. In the following description, it will be understood that each block of the flowchart illustrations, and combinations of blocks in the flowchart illustrations, can be implemented by computer-program instructions. These computer-program instructions may be loaded onto a computer or other programmable apparatus to produce a machine such that the instructions that executes on the computer or other programmable apparatus create means for implementing the functions specified in the flowchart block or blocks. These computer-program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer-program instructions may also be loaded onto a computer or other programmable apparatus to cause a series of operational steps to be performed in the computer or on the other programmable apparatus to produce a computer-implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special-purpose hardware-based computer systems that perform the specified functions or steps, or combinations of special-purpose hardware and computer instructions.

In a preferred embodiment the present invention can be implemented in software. Software-programming code that embodies the present invention is typically accessed by a microprocessor from long-term, persistent storage media of some type, such as a flash drive or hard drive. The software-programming code may be embodied on any of a variety of known media for use with a data-processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software-programming code in memory, on physical media, and/or distributing software code via networks are well known and will not be further discussed herein.

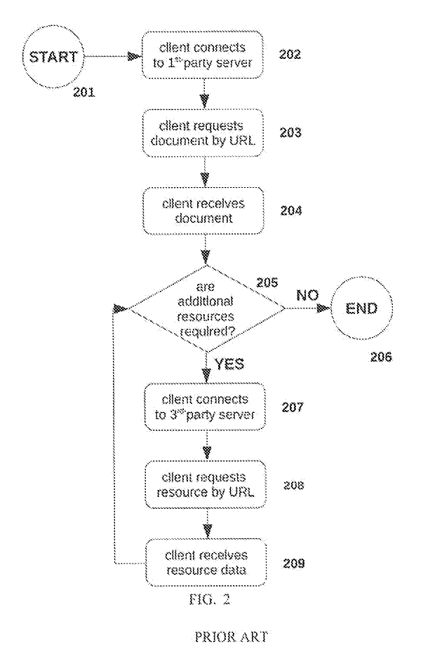

The detailed sequence of steps performed in the conventional system 100 is best understood with reference to the flowchart provided in FIG. 2.

In step 202 the client (101) initiates a download by connecting to a 1^{st} party server (102) that hosts a desired document (103). After connecting to the 1^{st}-party server, the client sends it a request (106), specifying the URL of the document (103) that it is seeking (step 203). In step 204, the 1^{st}-party server returns (107) the requested document to the client. The client may now determine that the document does not specify any additional required resources (step 205), in which case the download process ends (step 206). After a client downloads a document, it may determine that it specifies additional associated resources (step 205). In this case it proceeds to download each additional resource (105) by connecting to a 3^{rd}-party server (104) specified in the resource URL (step 207), requesting (108) the URL (step 208), at which point it receives (109) the element data (step 209).

In an embodiment in which the client has been preloaded with a document, steps 202, 203 and 204 are unnecessary, as the client already possesses a document identifying any additional required resources. The process proceeds immediately to step 205 and proceeds normally.

Tools that tamper with the display of advertising on websites, as described in the Background to the Application above, act to disrupt clients 101 as they connect to 3^{rd}-party servers 104 to download additional resources (105), such as advertising images. These tools are usually implemented as web-browser extensions, which modify the behavior of the client 101, or as network filters, which disrupt messaging between the client 101 and the 3^{rd}-party server. Network filters perform deep packet inspection (DPI) to identify resource URLs, or DNS poisoning to prevent resource requests reaching 3^{rd}-party servers.

The inventors have found that tampering tools in the client monitor and selectively block resource requests 108 using application programming interfaces (APIs) provided by the client 101. It should be understood that not all network requests are exposed through these APIs, and any protocol which is not exposed is “tamper proof” against these tools.

In addition the inventors have found that network-filter tools, which monitor and selectively block resource requests using DPI, can only inspect unencrypted packet data. It should be understood that any protocol which encrypts request content is “tamper proof” against these tools.

Finally the inventors have found that network-filter tools, which prevent resource requests reaching the 3^{rd}-party server 104 by DNS poisoning, require that resource URLs contain a domain name so that a DNS lookup is required. It should be understood that any request that specifies an IP address rather than domain name is “tamper proof” against these tools.

The inventors have identified Web Real-Time Communication (WebRTC) as a protocol that, with some inventive steps, is tamper proof. Established WebRTC connections are not exposed to tampering tools through client APIs; requests through a WebRTC connection are encrypted preventing DPI; and connections are established between IP addresses without DNS lookups.

In particular, the inventors have developed a tamper-proof system and method of establishing WebRTC connections. Once established a client requests resources through the tamper-proof channel. It should be understood that a resource, which is normally the subject of tampering techniques or tools described previously, becomes a “protected resource” when it is downloaded through a tamper-proof channel.

WebRTC is a peer-to-peer (P2P) communication protocol. P2P is a decentralized communications model where either peer can initiate a communication session. This is in contrast to the more frequently used client-server model, where a client makes a service request and the server fulfills the request. In a P2P model each peer functions as both a client and a server.

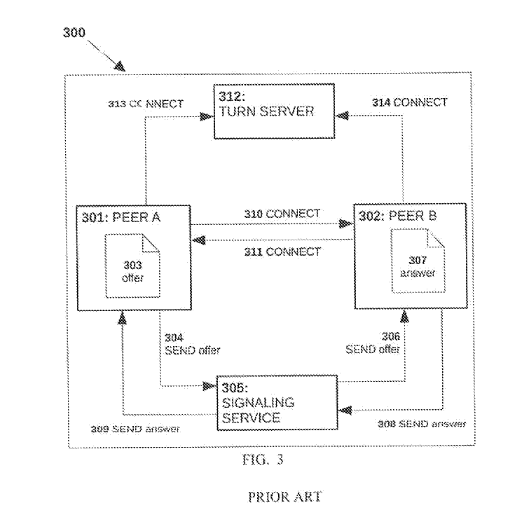

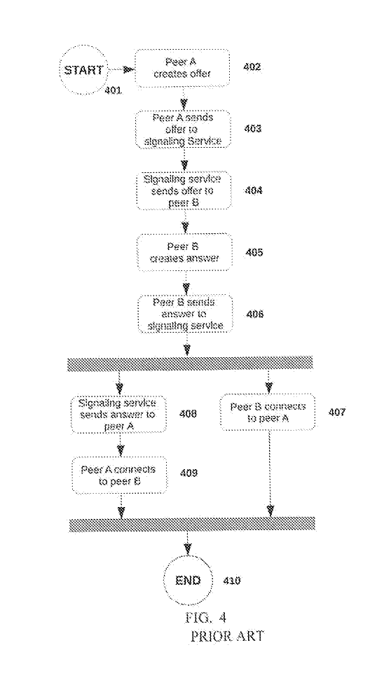

The conventional system and method for establishing a WebRTC connection is best defined with reference to FIG. 3 and FIG. 4. The protocol requires peers to exchange information so they can connect to each other, such as IP addresses and ports. It should be understood that an “offer” refers to the information that the peer who initiates the connection must send, and an “answer” refers to information the other peer must send. The method of exchanging offer and answer is not specified by WebRTC, however they are often exchanged through a well-known server using protocols such as HTTP or WebSocket.

In system 300 Peer A 301 and Peer B 302 establish a WebRTC connection between them. Peer A creates an offer 303 containing, among other things, its IP address. The method of identifying its IP address is beyond the scope of this invention, however the Session Traversal Utilities for NAT (STUN) protocol is often used. Peer A sends 304 the offer to a well-known signaling service 305, which forwards 303 the offer to peer B. Peer B creates an answer 307 that contains, among other things, its IP address. The answer is sent back (308, 309) to peer A via the signaling service. Peer A and peer B use the information contained in the answer and offer respectively to connect to each other (310, 311).

In some scenarios a Traversal Using Relays around NAT (TURN) server acts as an intermediary between WebRTC peers; for example if peers cannot connect directly to each other. In such scenarios the method of exchanging offer and answer is unchanged. Peer A and peer B connect (312, 313) to the TURN server 311, which relays their requests, rather than directly to each other (310, 311).

The detailed sequence of steps performed in the conventional system 300 is best understood with reference to the flowchart provided in FIG. 4.

In step 402 peer A (301) creates an offer 303. In step 403 peer A sends the offer to a signaling service 305, which forwards the offer to peer B 302 in step 404. In step 405 peer B creates an answer 307 and then sends it to the signaling service (step 406). Peer B commences connecting to peer A (step 407). In parallel the signaling service forwards the answer to peer A (step 408) and peer A connects to peer B (step 409). In scenarios where a TURN server acts as an intermediary, peer A connects to peer B through TURN (step 409) and peer B connects to peer A through TURN (step 407).

Although a WebRTC connection is tamper proof once established, the exchange of offer and answer via a signaling service is normally performed using protocols that are not tamper-proof, for example HTTP or WebSocket. Tampering tools can prevent a WebRTC connection being established by interfering with this exchange between peers. The invented system and method ensures that the exchange of offer and answer is also tamper-proof, so that a WebRTC connection can be established and used to download protected resources onto a client.

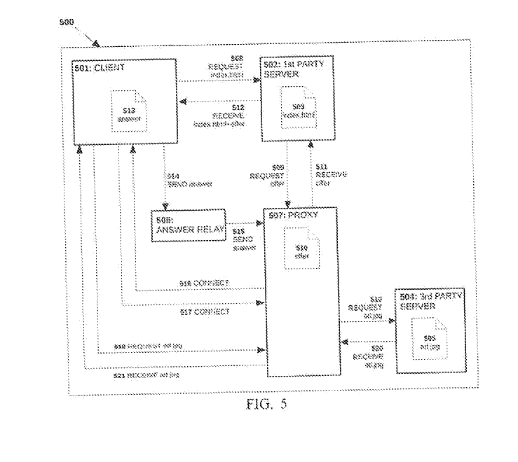

The teachings of the present application require the combination of components from conventional systems 100, 300 described in FIG. 1, FIG. 3, as well as the introduction of new components. As can be seen in FIG. 5 new answer relay 506 and proxy 507 components are introduced. In FIG. 5, the components and steps 501 to 505 correspond respectively to the components and steps 101 to 105 of FIG. 1.

When comparing FIG. 1 and FIG. 5, it should be noted that the client 501 no longer directly connects to the 3^{rd}-party server 504 to download the resource 505 (called “ad.jpg” in this example). This connection instead passes through the proxy 507. The client 501 establishes a tamper-proof WebRTC channel to the proxy 507. Requests for resources, referred to in documents such as document 503, pass through this channel and tampering tools cannot interfere with these resource requests for the reasons outlined previously. An established WebRTC connection is one embodiment of a tamper-proof channel. In another embodiment a different tamper-proof protocol could be used for the same purposes. One such embodiment would use the Action Message Format (AMF) protocol to establish a tamper-proof channel.

In an embodiment of FIG. 5, the publisher who operates the first-party server 502 may gain access to a tamper-proof channel by entering into a commercial arrangement with the business that operates the new components 506 and 507 as a service. In most cases, this will be possible without the involvement of the 3^{rd}-party servers 504. Many publishers may simultaneously use one service in this way.

An example of such a commercial agreement is illustrated as follows. A website “X” is primarily funded through the sale of advertising space on its webpages. An analysis has been performed by comparing the number of downloads of web pages to that of advertising images, demonstrating that a large percentage of the website's audience is using tampering tools. The website “X” enters into an agreement with a tamper-proof-channel service provider. The website's documents are then modified so that the tamper-proof channel is established between client and proxy. In addition the documents are modified so that advertising or other protected resources are downloaded through the tamper-proof channel. Many other websites may also be in the same position as website “X”, and enter into similar commercial agreements, permitting them to also integrate their websites with the tamper-proof-channel service.

The complete system developed by the inventors is best understood with reference to FIG. 5, which depicts the interactions of the components. These interactions are presently discussed in detail.

In the system developed by the inventors the client 501 and proxy 507 components take the roles of peer A and peer B in FIG. 3. After the operator of the 1^{st}-party server 502 enters into an agreement with the provider of the tamper-proof-channel service, the 1^{st}-party server is modified as follows. When it receives a client request 508 the 1^{st}-party server in turn requests 509 an offer 510 from the proxy 507. In another embodiment the offer may be accessed by some other method, for example an offer may be hardcoded on the 1^{st}-party server as part of the operator's integration steps.

The 1^{st}-party server returns document+offer 512 to the client. It should be noted that although document+offer is not downloaded through a tamper-proof channel, tampering tools must allow the request 508 and response 512 succeed in order to access the content offered by the publisher. This ensures that the offer is delivered to the client.

The client creates an answer 513 and it is sent 514 to the answer-relay service 506 operated by the tamper-proof-channel service provider. The answer must be sent from the client to the answer relay using a tamper-proof protocol. There are a number of protocols that allow the client to “piggyback” or encode the answer within a protocol message. Some options include: sending the answer in the username field of a STUN request; sending the answer in the username field of a TURN request; encoding the answer in a DNS request.

Depending on the specific protocol used, the answer relay 506 contains logic to extract the piggybacked or encoded answer from the protocol message. The answer relay forwards the extracted answer to the proxy 507. At this point the peers (client and proxy) have exchanged sufficient information to establish a WebRTC connection. Each peer connects to the other (517, 516) using the details in offer and answer, establishing a tamper-proof WebRTC connection.

For clarity the TURN server 311 in FIG. 3 is omitted from FIG. 5. In scenarios where client and proxy cannot establish a direct WebRTC connection, connections 517 and 516 are replaced with connections to a TURN server. This does not change the developed system of offer/answer exchange.

Client requests 518 for protected resources via the WebRTC channel are proxied to 3^{rd}-party servers (519, 520). In some embodiments the proxy may optimize this process by returning a cached version of the resource, which has been recorded from a previous request for the same resource. In another embodiment the invented method of offer/answer exchange may be used to establish a connection using a protocol other than WebRTC. Some protocols may only require uni-directional transfer of information, so in another embodiment the same method of offer delivery may be used to establish a connection for such protocols. In another embodiment the proxy 507 component may be a modified TURN server. Such a component could perform the roles of answer relay (extracting the client's answer from TURN requests), WebRTC peer (establishing a connection with the client) and proxy (forwarding protected-resource requests to 3^{rd}-party servers).

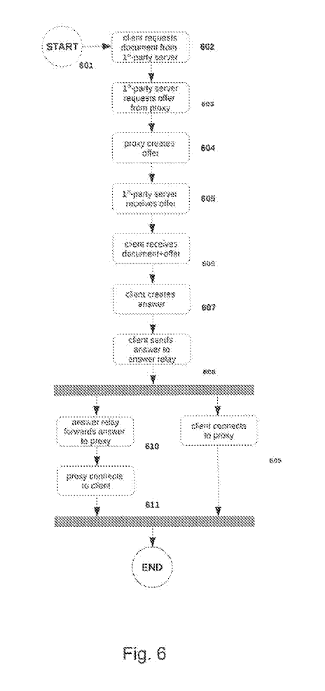

FIG. 6 illustrates the steps that are performed by the system of FIG. 5 to establish a tamper-proof channel, in contrast to those presented for the conventional system in FIG. 4.

In step 602 the client (501) sends a request to a 1^{st}-party server (502), specifying the URL of the document (503) that it is seeking. The 1^{st}-party server requests an offer from the proxy 507 (step 603), the proxy creates an offer 510 and returns it to the 1^{st}-party server (steps 604, 605). The 1st-party server returns document+offer to the client (step 606), which creates an answer 513 (step 607). In step 608 the client sends the answer to the answer relay 506. The client commences connecting to the proxy (step 611). In parallel the answer relay forwards the answer to the proxy in step 609 and the proxy proceeds to connect with the client (step 610).

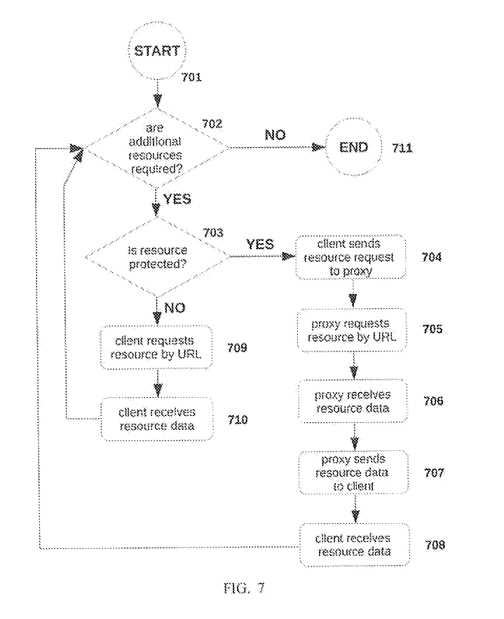

FIG. 7 illustrates the steps that are performed by the system of FIG. 5 to load protected resources, in contrast to those presented for the conventional system in FIG. 2. FIG. 7 captures the steps after FIG. 6, where a tamper-proof channel has been established between client 501 and proxy 507, and the client has a document 503 that may specify required resources. The client may determine that the document does not specify any additional required resources (step 702), in which case the download process ends (step 711). The client may also determine that the document specifies additional associated resources 505 (step 702) and proceed to download each additional resource. If a resource is protected (step 703) the client sends a request 518 via the tamper-proof channel to the proxy (step 704). The proxy requests the resource by URL from the 3^{rd}-party server 504 (step 705). When the proxy receives the 3^{rd}-party server response (step 706) it sends the resource to the client over the tamper-proof channel (step 707). Alternatively, if a resource is not protected (step 703) the client proceeds to download it directly from the 3^{rd}-party server specified in the resource URL (steps 709, 710).

As a consequence of the current system, the client will request one or more protected resources via the WebRTC channel. Because the WebRTC channel is established and communicates resource requests in a tamper-proof way, it is impossible to disrupt the loading of these resources.

In an embodiment, the invention provides a system to ensure that the downloading of advertising content cannot be tampered with by ad-blocking tools. By virtue of this anti-tampering system, a website can now ensure that its content can only be enjoyed in conjunction with the intended advertising.

In another embodiment, the invention provides a method to ensure that javascript source code resources are downloaded. Javascript resources provide a useful and convenient way to extend the functionality of the web page with interactive features, to track data for the purposes of business intelligence or to download additional content into the web page, such as advertising images. By virtue of the present system, it becomes impossible for tampering tools to selectively block a javascript resource that is loaded through the tamper-proof channel.

In another embodiment, the invention provides a method to ensure that communication between the client and a server is not blocked. For example, javascript code included on a web page may be required to report data to a 3^{rd}-party analytics system. Such services are made available via web APIs. Clients connect to a web API in the same way they connect to a web server to download a file, using a URL. By virtue of the present system, it becomes impossible for tampering tools to block communication between client and server through the tamper-proof channel.

The words comprises/comprising when used in this specification are to specify the presence of stated features, integers, steps or components but does not preclude the presence or addition of one or more other features, integers, steps, components or groups thereof.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the inventions or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three.

Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

What is claimed:

1. A method of providing content to a client over a networked architecture, the method comprising:
Receiving at a web server a request from a client specifying a URL of a document for delivery to the client;
Establishing by the web server peer-to-peer connection information of a proxy server and communicating details of that connection to the client to facilitate client connection through a peer-to-peer connection with the proxy server;
Facilitating provision of data referenced by the document of the URL specified by the client and provided by a third party server through the proxy server and via the peer-to-peer connection with the client.

2. The method of claim 1 wherein the peer-to-peer connection is via a Web Real-Time Communication protocol.

3. The method of claim 1 comprising on receipt of the request from the client providing the client with the document specified in the URL.

4. The method of claim 3 comprising, the client, on receipt of the document from the webserver, effecting a determination that additional data, as referenced within the document retrieved, is required and initiating the peer-to-peer connection with the proxy server, the proxy server being configured on establishment of the peer-to-peer connection with the client to request the additional data from the third party server and to relay the data received in response to that request to the client using the peer-to-peer connection with the client.

5. The method of claim 1 wherein the data referenced by the document of the URL comprises executable code.

6. The method of claim 1 wherein the data referenced by the document of the URL comprises one or more advertisement files which for display on a user interface of the client.

7. The method of claim 1 wherein the facilitating provision of data referenced by the document of the URL specified by the client comprises providing data from the client to a third party server through the peer-to-peer connection established between the client and the proxy server.

8. The method of claim 1 wherein establishing by the web server peer-to-peer connection information of a proxy server and communicating details of that connection to the client comprises:
a. The web server requesting an offer from the proxy and in response the proxy creating an offer returning it to the web server;
b. The web server returns the document requested by the client and the offer returned by the proxy server to the client.

9. The method of claim 8 wherein the connection between the client and the proxy server is effected by:
a. The client in response to receipt of the offer creating an answer and sending the answer to an answer relay;
b. The client initiating connecting to the proxy server and concurrent with that connection initiation, the answer relay forwarding the answer to the proxy so as to facilitate the establishment of the peer to peer connection between the proxy and the client.

10. An article of manufacture, comprising: a non-tangible computer readable storage medium having machine readable instructions embodied thereon which, when executed by a processor, cause the processor to execute the steps of:
Receive at a web server a request from a client specifying a URL of a document for delivery to the client;
Establish by the web server peer-to-peer connection information of a proxy server and communicating details of that connection to the client to facilitate client connection through a peer- to- peer connection with the proxy server;
Facilitate provision of data referenced by the document of the URL specified by the client and provided by a third party server through the proxy server and via the peer-to-peer connection with the client.

11. The article of manufacture of claim 10 wherein the peer-to-peer connection is via a Web Real-Time Communication protocol.

12. The article of manufacture of claim 10 wherein the machine readable instructions, when executed by a processor, cause the processor to execute the step of, on receipt of the request from the client, provide the client with the document specified in the URL.

13. The article of manufacture of claim 12 wherein on receipt of the document from the webserver, the client effects a determination that additional data, as referenced within the document retrieved, is required and initiates the peer-to-peer connection with the proxy server, the proxy server being configured on establishment of the peer-to-peer connection with the client to request the additional data from the third party server and to relay the data received in response to that request to the client using the peer-to-peer connection with the client.

14. The article of manufacture of claim 10 wherein the data referenced by the document of the URL comprises executable code.

15. The article of manufacture of claim 10 wherein the data referenced by the document of the URL comprises one or more advert files which for display on a user interface of the client.

16. The article of manufacture of claim 10 wherein the facilitating provision of data referenced by the document of the URL specified by the client comprises providing data from the client to a third party server through the peer-to-peer connection established between the client and the proxy server.

17. The article of manufacture of claim 10 wherein establishing by the web server peer-to-peer connection information of a proxy server and communicating details of that connection to the client comprises:
a. The web server requesting an offer from the proxy and in response the proxy creating an offer returning it to the web server;
b. The web server returns the document requested by the client and the offer returned by the proxy server to the client.

18. The article of manufacture of claim 17 wherein the connection between the client and the proxy server is effected by:
a. The client in response to receipt of the offer creating an answer and sending the answer to an answer relay;
b. The client initiating connecting to the proxy server and concurrent with that connection initiation, the answer relay forwarding the answer to the proxy so as to facilitate the establishment of the peer to peer connection between the proxy and the client.

19. A computer architecture comprising a client, a web server and a proxy server; the architecture comprising at least one processor which effects on execution a processing of the method of claim 1.
